(19) United States
(12) Patent Application Publication
(10) Pub. No.: US 2004/0039767 A1
(43) Pub. Date: Feb. 26, 2004

(54) Check sum generation for modular reduction

(75) Inventors: Chin-Long Chen, Fishkill, NY (US); Vincenzo Condorelli, Poughkeepsie, NY (US); Samir K. Patel, Wappingers Falls, NY (US)

Correspondence Address: LAWRENCE D. CUTTER, IBM Corporation, Intellectual Property Law Dept., 2455 South Rd., M/S P386, Poughkeepsie, NY, 12601, US

(73) Assignee: International Business Machines Corporation, Armonk, NY

(21) Appl. No.: 10/224,744

(22) Filed: Aug. 21, 2002

(51) Int. Cl. G06F 7/00

(52) U.S. Cl. 708/492

(57) ABSTRACT

To check hardware logic, one can duplicate the logic and compare the results from identical circuits. One can also use a check sum technique that predicts the check sum for the expected result and compare it against the check sum of the actual result produced by the hardware circuits. The present invention employs this technique for hardware which performs modular reduction operations which compute (A mod N) which is the calculation of the remainder of A divided by N, which can be expressed as B=N−AQ for some quotient Q. When R is the integer used as the modulus for the check sum, the check sum approach predicts the check sum of the remainder, that is, the check sum of (N−AQ) mod R. If C(x)=x mod R is the check sum of x, the predicted check sum is C(N−AQ)=(C(N)−C(A)C(Q)) mod R. Thus, a multiplier is normally required to calculate the predicted check sum. However, the present invention provides a method and circuits for generating the predicted check sum for modular reduction that does not require a multiplier. Instead, a simple shift register is used. Thus, the complexity of circuits employed to generate predicted check sums is greatly reduced.

### BACKGROUND OF THE INVENTION

The present invention is directed to a method and system for providing a check sum in modular reduction processes. Modular reduction is an elementary operation in most public-key cryptographic methods.

However, for long cryptographic keys, a significant amount of hardware is required to implement modular reduction. Because of the significant hardware requirements, it is desirable to employ a check sum technique to check that the hardware always produces a correct output.

The modular reduction of A modulo N is the remainder of A divided by N. For cryptographic applications, N and A are large integers expressed as long strings of binary bits. There are essentially two algorithms for the calculation of modular reduction. The conventional algorithm is the long division of one long binary string by a short one. This algorithm iteratively reduces the length of the long binary string starting from the its most significant bits. On the other hand the Montgomery algorithm is a relatively new algorithm that processes the binary string starting from its least significant bits. Because the Montgomery algorithm requires preprocessing and post-processing operations, it is not efficient for the calculation of a single modular reduction operation.

Check sum calculations are desirable for providing checks to make sure that two independently generated check sums for the result of the calculation are identical. That is, it is desirable to compute a predicted check sum for the calculation and then to check to see that it is the same as the check sum of the actual result of the calculation. A check sum of an integer is the integer modulo a preselected modulus R.

### SUMMARY OF THE INVENTION

In the present application there is described a method of generating the predicted check sum of the result of a modular reduction using a check sum modulus R. For ease of hardware implementation, R is selected to be of the form (2′−1). In particular, in preferred embodiments of the present invention i is set to be 32 so that R is 2³²−1.

In accordance with a preferred embodiment of the present invention, a circuit for check sum generation used in the computation of A modulo N, comprises a rotator register, an accumulating register and a modular adder. The output of the adder is provided as an input to the accumulating register which also receives an initial value for the check sum of A. The inputs to the adder are the two outputs from the rotator register and the accumulating register. The rotator register receives two inputs: a value that determines the amount and direction of bit rotation and an initial value for the check sum of N.

Accordingly, it is an object of the present invention to enhance and improve cryptographic algorithms.

It is also an object of the present invention to improve the efficiency and accuracy of modular arithmetic operations, particularly modular multiplication.

It is a still further object of the present invention to provide a process for check sum generation in modular reduction operations.

Lastly, but not limited hereto, it is an object of the present invention to speed up check sum generation.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a flow chart illustrating a process for the calculation of A mod N with the concomitant generation of a check sum for the operation;

FIG. 2 is a diagram illustrating the structure and contents of a check sum register during the modular reduction process; and

FIG. 3 is a flow chart and hardware description of a circuit for performing check sum generation in modular reduction.

### DETAILED DESCRIPTION OF THE INVENTION

The present invention is best understood in two parts. First there is described the overall process of modular reduction in which the check sum is desired. The second part describes the check sum method and system.

### Modular Reduction Algorithm

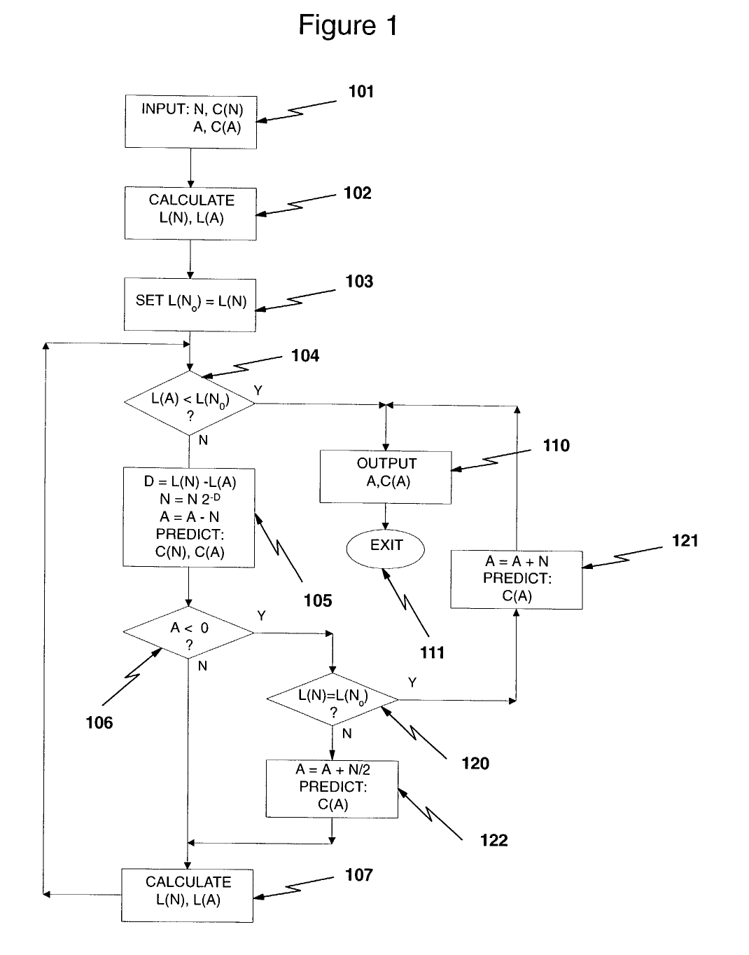

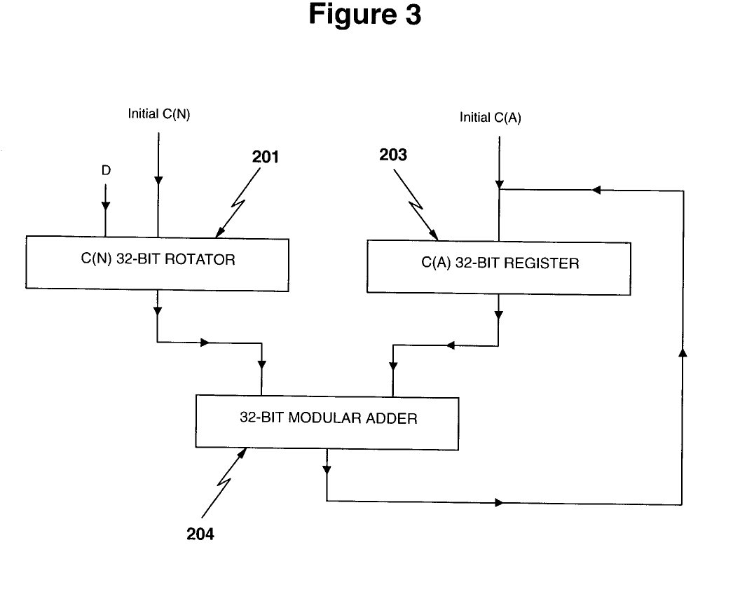

A process for the modular reduction of A mod N and for the generation of the associated check sums is shown in FIG. 1. It is assumed, for the sake of example and for the purpose of describing presently preferred embodiments, that the check sum modulus, R, is equal to 2′−1 with i=32. The process shown in FIG. 1 iteratively finds the remainder of a long division of A by N. The process starts with the inputs A and N and the associated check sums C(A) and C(N), for A and N, respectively (see step 101). The lengths of the binary representations for the numbers N and A are determined and are designated in the process flow chart of FIG. 1 as L(N) and L(A) respectively (see step 102). Then, the value for the variable L(N₀) is set to be equal to the just determined value for L(N) (see step 103). If it is determined that the length of A, that is, L(A) is less than L(N₀), the process outputs the current values of A and its check sum, C(A) (see step 110) and then halts (see step 111). In each iteration, N is shifted by D bits (step 105) so that the most significant bit of N lines up with the most significant bit of A, where D is the difference of the effective lengths of the binary strings representing N and A, computed as “L(N)−L(A)” in step 105, as shown. The effective length of a binary string is the length of the string not counting the zeros in its most significant bit positions. The shifting operation is then followed by a subtraction of N from A (also shown in step 105 as: A=A−N). Lastly, as shown in step 105 of FIG. 1, current checksum values for C(N) and C(A) are generated. The circuit for generating these checksums is shown in FIG. 3 and is discussed in more detail below. However, as noted above, it is at this point that the two portions of the description of the present invention mesh together. In particular, it is noted that the present invention is directed to a method and circuit for checksum generation; that generation occurs within the operation of a modular reduction process, and particularly within the process illustrated in FIG. 1.

If the resultant value for A is negative (as determined in step 106), A is replaced by the value (A+(N/2)) (see step 122) whenever L(N)>L(N₀) (see step 120) otherwise, A is replaced by A+N whenever L(N)=L(N₀) (step 121). If L(N)>L(N₀), the current value of N is shifted left at least one position from the original starting value for N. Thus the current N is even. An updated value for the checksum, C(A), is also determined after the addition to A of either N or N/2 (in steps 121 and 122, respectively).

If the resultant value for A is positive (as determined in step 106), new values for the lengths of A and N, namely L(A) and L(N), are determined (see step 107). The process for the modular division algorithm stops when L(A) is less than L(N₀) (see step 104) or when A is negative (step 106) and L(N) is equal to L(N₀) (step 120), where L(N₀) is the effective length of the initial value for N.

In each iteration of the process for modular division show in FIG. 1, as the values of N and A are recalculated, predicted check sums, C(N) and C(A), for the new values of N and A are generated. Next is described an efficient and easily implemented mechanism for generating (predicting) check sums for N and A.

### Check Sum Generation

The check sum of the product of two integers A and B is C(AB)=C(A)C(B) mod R. In general, the operation involves a multiplication of two integers C(A) and C(B) and a modular reduction with the modulus R. For a 32-bit modulus R, the hardware normally requires a 32-bit multiplier that produces a 64-bit product and logic that performs the modular reduction of the 64-bit product to a 32-bit predicted check sum. However, if one selects appropriate values for R, such as R=2³²−1, the hardware requirements can be greatly simplified. In general, R is selected to have the form 2″−1 where n is power of 2 such as 16, 32, 48, 64, etc. depending on the basic word size of the processor employed.

When B is a power of two, C(AB)=C(A2^{k})=C(A)C(2^{k}). Advantage is now taken of the assumption herein that R=2³²1. In particular, it is easily seen that the check sum of 2^{k} is C(2^{k})=2^{k} mod R=2^{(k mod 32)}. Suppose that “k[4:0]” is the integer representing the five least significant bits (that is, bits 0, 1, 2, 3 and 4) of the binary string representing k. Here, it is seen that five is chosen since 32=2⁵. Thus, C(2^{k})=2^{k[4 0]}and C(A2^{k})=C(A)C(2^{k})=C(A)2^{k[4 0]}mod R. Thus, C(A2^{k}) is equal to the 32-bit binary string of C(A) cyclically rotated to the left by k[4 0] bit positions. For hardware implementation, a 32-bit multiplier is thus not required in this case.

In FIG. 1, the predicted check sums of N and A are generated whenever new values of N and A are obtained. In general, it is desired to generate the check sum of N2^{k} and the check sum of A+B or A−B for some B that is a function of N.

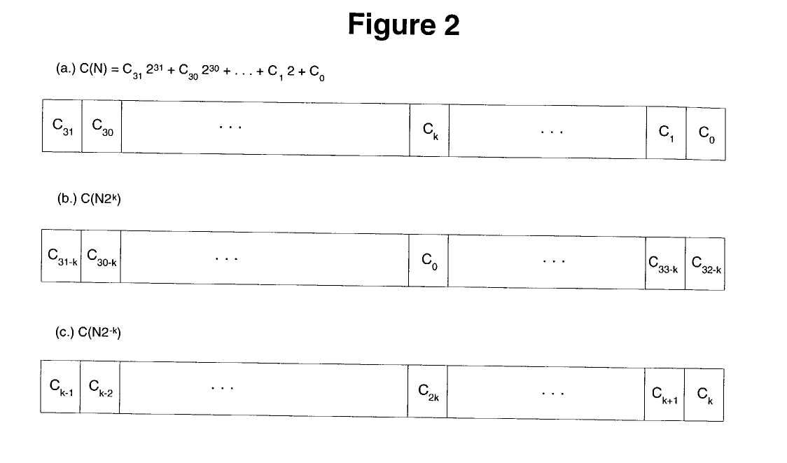

The predicted value of the check sum C(N2^{k}) can be implemented in the manner depicted in FIG. 2. Suppose that we have C(N)=C₃₁2³¹+C₃₀2³⁰+. . . +C₂2²+C₁2+C₀ stored in a register as shown in FIG. 2a. If k is positive, then C(N2^{k})=C₃₁₋ₖ2³¹+C₃₀₋ₖ2³⁰+. . . +C₀2^{k}+C₃₁2^{k-1}+. . . +C₃₃₋ₖ2+C₃₂₋ₖ is generated by cyclically rotating the content of the register shown in FIG. 2a to the left by k bits (see FIG. 2b for the result). If k is negative, then C(N2^{k}) is generated by cyclically rotating the content of the register in FIG. 2a to the right by k bits (see FIG. 2c). Therefore, the generation of the check sum for the predicted value of C(N) in FIG. 1 is seen to be implementable through the use of a 32-bit register with the capability of cyclically rotating bits. Note that C(N)2^{-D} mod R is equal to C(N)2^{32-D} mod R. Rotating a register to the right by D bits is the same as rotating the register to the left by 32−D bits.

The predicted check sum of A+B is therefore (C(A)+C(B)) mod R. This modular addition is accomplished using a 32-bit adder that wraps and adds the carry bit to the least significant bit of the sum. That is, if C(A)+C(B)=C₃₂2³²+C₃₁2³¹+C₃₀2³⁰+. . . +C₂2²+C₁2+C₀, then the final check sum value is (C(A)+C(B)) mod R=(C₃₁2³¹+C₃₀2³⁰+. . . +C₂2²+C₁2+C₀)+C₃₂. To perform the modular difference operation (C(A)−C(B)) mod R, one uses the formula (C(A)+(2³²−1−C(B))) mod R. Note that 2₃₂−1−C(B) is equals to the complement of all the bits in C(B).

A diagram for a preferred embodiment for the circuits desired for performing predicted check sum generation for the check sums C(N) and C(A) is shown in FIG. 3. Initial values of C(N) and C(A) are loaded into two 32-bit registers, 201 and 203 respectively. In general, if R 2″−1, then registers 201 and 203 are each n bits long. Register 201 is a rotator or end around shift register capable of rotating its contents to produce C(N)2^{D} mod R. At each iteration of the process shown in FIG. 1, a new value of C(N) is obtained by rotation of the old value of C(N). The rotation or end around shift is carried out using the current value for D. A new value for the predicted check sum C(A) is obtained by modular adder 204 that adds the old value of C(A) to the new value of C(N), as shown. A modular adder is simply a normal adder for positive integers that wraps and adds the carry bits to the least significant bit of the sum (as described in the two preceding paragraphs).

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

The invention claimed is:

1. A circuit for check sum generation in computing A modulo N, said circuit comprising:
an end around shift register with a first input for receiving an initial value for the check sum of N and a second input for receiving a value that determines the amount and direction of bit rotation;
an accumulating register with an input for receiving an initial value for the check sum of A;
a modular adder with two inputs receiving the outputs from said end around shift register and said accumulating register;
a feedback connection from said adder to the input of said accumulating register.

2. The circuit of claim 1 in which said rotator register is 32 bits in length.

3. The circuit of claim 1 in which said accumulating register is 32 bits in length.

4. The circuit of claim 1 in which said modular adder is 32 bits in length.

5. A method for generating a check sum in a process for computing A modulo N, said method comprising the steps of:
providing an initial value for the check sum of N to an end around shift register;
providing an initial value for the check sum of A to a storage register;
providing to said end around shift register a current value, D, for the difference in bit lengths for N and A;
shifting, in end around fashion, the contents of said shift register by D bit positions;
adding together in a modular adder the contents of said end around shift register and said storage register;
storing the output of said modular adder in said storage register; and
iteratively repeating the previous steps subsequent to the initial value providing steps.
